(19) United States
(12) Patent Application Publication
(10) Pub. No.: US 2015/0366737 A1
(43) Pub. Date: Dec. 24, 2015

(54) Vein Pump

(71) Applicant: Feng-Ling Wang, Eagle, ID (US)

(72) Inventor: Feng-Ling Wang, Eagle, ID (US)

(21) Appl. No.: 14/309,889

(22) Filed: Jun. 19, 2014

(51) Int. Cl. A61H 1/02

(52) U.S. Cl. CPC A61H 1/0244; A61H 1/0266; A61H 2201/12; A61H 2205/106; A61H 2205/088

(57) ABSTRACT

Disclosed is a motorized dual motion passive action rehabilitation and exercise apparatus for the lower extremities. The use of a fully automatic exercise apparatus allows a person to exercise their lower extremities and achieve adequate range of motion in their ankle, knee, and hip joints without having to engage in active, physical activity or with the assistance of another person. The pre-set speed, motion, and angle of the moving parts of the apparatus provide a steady and optimal movement to maximize therapeutic benefit while preventing injury caused by over excursion of the joints and muscles. The movement achieved by the use of the apparatus allows a person's calves muscles to be contracted and relaxed at an optimal level to encourage blood and lymphatic fluid circulation.

### CROSS-REFERENCE TO RELATED APPLICATIONS

This application claims the benefit of U.S. Provisional Application No. 61/838,173, filed Jun. 21, 2013, entitled “Vein Pump.” The patent application identified above is incorporated here by reference in its entirety to provide continuity of disclosure.

### STATEMENT REGARDING FEDERALLY SPONSORED RESEARCH OR DEVELOPMENT

Not Applicable.

### BACKGROUND OF THE INVENTION

The present invention relates to the field of rehabilitation equipment and motorized exercise machines for the dual motion passive action of the lower extremities including the legs and feet. Specifically, the present invention relates to a novel method and system for the exercise and movement of the lower extremities including the legs and feet causing muscle contractions in the lower extremities without the necessity of the person to exert effort or create movement by using a motorized exercise machine. The present invention is also further applicable to receive the proper amount of circulation and remove blood stasis and fluid and from the limbs.

Conventional methods used to reduce edema and blood stasis as well as improve blood circulation in the legs require the use of a person's deliberate movement of their feet and lower limbs. This movement is often limited by a person's failure or inability to walk regularly. Currently manual assistance is provided by another person which requires the presence and work of another to create the necessary muscle contractions in the person's lower limbs. This current lack of movement often leads to blood stasis, edema, skin ulcers, skin coloring, dermatitis in the legs, restless leg syndrome, arthritis, blood clots, and neuropathy.

The use of a fully automatic exercise apparatus allows a person to exercise their lower limbs without the assistance of others, without having to engage in the physical movement of walking, and provides movement at a steady and optimal speed to maximize benefit while preventing problems related to over exertion of the person. The average person walks less than 350 yards per day. The average person needs to exercise and walk much more than this in order to achieve health and prevent blood clots and other diseases of the lower limbs. This invention creates the motion that allows the vein valves to pump blood back to the heart thus promoting the required motion of the legs and circulation of the blood. The invention allows a person to sit and achieve movement of the lower limbs.

It is an object of the present invention to provide a method and a system for the proper and safe contraction of the muscles of the lower limbs to facilitate the proper and necessary movement and circulation of lymph and blood. It is also an object of the present invention to provide a method and a system for allowing a person to achieve lower limb muscular, lymph, and blood health regardless of their current range of motion or ability to move their own muscles. Another object of this invention is to provide a commercially practical method for the exercising of the lower limbs while utilizing conventional components in a novel fashion. A specific object of the invention is to provide a safe and effective method for improving blood and lymph circulation in a person and reducing the risk of edema, neuropathy, and other diseases caused by lack of motion and poor circulation. A further object of the present invention is to provide a technique that decreases a person's need for and reliance on manual physical therapy exercises and assistance while saving valuable time and improving overall health in a very cost-effective manner.

The method of this invention is particularly suited for the elderly and those who are not able to walk because they have to remain seated while working. The present invention advances the art of achieving health through deliberate and targeted exercise. This invention provides a method of exercise that does not require the use of manual assistance and is safe for the person while reducing the cost of care for the person.

Legs are considered to be the second heart. Blood pumps out of the heart, but it cannot be vacuumed back into the heart. Muscles contractions are necessary in order to move the blood through the veins back into the heart. When a person is sitting or standing upright their feet and calves' circulation must light gravity in order to pump blood back into the heart and lymphatic fluids back into circulation for filtration and removal of waste products. The veins in the feet and calves are one-way valves which only permit the flow of blood in one direction towards the heart. When a person is walking or moving their feet and leg muscles contract or squeeze allowing blood in the veins to be pushed back towards the heart. When a person is sitting or standing still the muscles of the feet and legs do not move or contract enough to allow blood to be pumped back to the heart and for lymphatic fluids to be pumped back towards the heart.

Improper movement or circulation of lymphatic fluid and blood is known as bloods stasis. Blood stasis can lead to varicose veins, blood clots, leg edema, restless leg syndrome, discomfort in legs and feet, leg and foot cramps, foot neuropathy, skin discoloration, and reduced immunity in the legs and feet leading to infections in the feet and calves, skin ulcers, open wounds, itchy skin, dermatitis, and even foot or leg amputation.

Many older people and people who live sedentary lives have hardened arteries and veins making it difficult for blood to adequately move through the veins back to the heart. This leads to poor circulation and other symptoms mentioned in paragraph 9.

This invention allows for the dual motion passive action of the feet and leg muscles creating muscle contractions at similar to those created at normal walking speed. This creates an effective pumping motion to move blood and lymphatic fluids back towards the heart leading to the prevention of the symptoms mentioned in paragraph 9.

In modern life there are more people who sit for long periods of time. Performing office work while seated is common. Physical work is rarely performed by most people. People sit most of the time while working, while watching television, and while on the computer or other electronic devices. These activities take up most of our time. Older people tend to sit a lot as well because they have existing medical conditions that make living an active lifestyle difficult. These reasons make it even more difficult for people to achieve adequate circulation in their feet and lower extremities. Prolonged blood stasis damages the physical structure of vein valves leading to varicose veins and blood clots and further inability for blood and lymphatic fluids to be properly pumped back towards the heart.

Blood stasis prevents nerves from receiving the nutrition they need causing nerve damage to develop. Nerve damage is also known as peripheral neuropathy and presents itself in the symptoms of burning, tightness, ache, restlessness, tingling, and numbness. Neuropathy is common in people who have poor blood circulation in their lower extremities. Foot neuropathy is the main reason older people lose their ability to balance. They cannot feel the ground beneath their feet due to poor blood circulation. Poor blood circulation causes blood clots to form in the calves. Most older people take blood thinning medications to help make it easier for blood to move back to the heart through hardened and narrowed veins. Physical movement of blood through the veins and movement of lymphatic fluid back towards the heart is a more effective treatment for blood stasis than taking medications. When a person lies down or reclines circulation improves because the pressure caused by the gravitational pull on the lower extremities is reduced. This is especially true for older persons and those who are less physically active. Reclining with the feet elevated above the heart is a common recommendation for older people with blood and fluid stasis in the lower extremities, however this should be avoided because this type of positioning can lead to pneumonia in older people because their bodies do not have the ability to process the excess fluid that is moved from their legs back towards their hearts and the extra fluid often settles in the lungs leading to pneumonia.

Poor circulation of the blood and lymphatic fluids in the legs can cause skin edema (water retention in the skin), inflammation in the skin and calf muscles, and dermatitis. When the skin around the feet, ankles, and calves becomes itchy it can lead to open wounds. Red blood cells can leak out of open wounds. This is why people with poor circulation in their lower extremities have permanently discolored skin on their calves. The present invention prevents and treats all conditions caused by poor blood and lymphatic fluid circulation.

Another symptom of poor blood circulation in the lower extremities can exhibit itself as knee pain. Swelling and pain can occur around the knee joint because of poor circulation. This can increase the risk of knee injury. The use of the present invention prevents strain on the knee while allowing for adequate movement to prevent blood stasis and encourage adequate movement of blood and lymphatic fluids back towards the heart.

The pressure created by the squeezing motion of muscle contractions can affect the entire body, especially the abdominal area. Poor circulation in the prostate can lead to prostatitis and other problems. Lower abdominal congestion is common in people who sit for long periods of time. Gravity causes drags organs downward and blood pressure in the abdomen increases. The movement of muscle contractions created by the present invention improves blood circulation in the abdomen as it forces blood in the abdomen back towards the heart. This movement can prevent and treat organ disorders caused by inactivity such as fibroids in the uterus, menstrual pain, enlarged prostate, constipation, etc. Adequate blood and lymphatic fluid circulation may reduce the risk of developing cancer in the ovaries, prostate, uterus, colon, etc. Adequate blood and lymphatic circulation can treat frequent night time urination because fluid is drained out the legs while a person is still awake instead of after a person has laid down to sleep. Inactivity and sitting for prolonged periods during waking hours prevents proper blood and lymphatic fluid circulation causing water retention to build up, once a person lies down the fluids will drain to the urinary bladder causing frequent night time urination. When a person's foot and calf immunity is reduced because of poor circulation infections, open wounds, ulcers, and dermatitis can result. When these conditions require the treatment with the use of antibiotics, intended results can be limited because without proper blood circulation the medication will not be able to reach the area where the medication is needed.

It is apparent that a need exists for a technique whereby a person is able to effectively move fluids and blood from their lower limbs. The present invention is directed toward providing such a technique. These and other objects of the invention will be apparent to those skilled in the art from the description that follows.

### SUMMARY OF THE INVENTION

The method and the system of this invention center around the innovative concept of providing automatic movement and range of motion to the ankle joints creating necessary and properly timed muscle contractions in the lower limbs, especially the calves. The invention allows a person, regardless of their ability to walk during the day or their disease or disability, to achieve adequate and proper blood and lymph flow from the lower limbs for proper circulation. This invention is especially suited to older individuals who have a naturally reduced ability to maintain healthy blood circulation due to the hardening of arteries and veins that is a natural part of the aging process.

The movement of this invention is preferable to other means of lower limb exercise because it requires no assistance and is pre-set and adjustable to ensure movements are not too fast to promote injury and not too slow to prevent adequate results. The motors may be encased within the unit. The moveable parts of the unit are made of a durable material and are not detachable. The unit is designed to rest flat on the floor. The pivoting foot platform allows for a slight inclination of the person's feet which will assist in the machine's ability to perform its intended task. The machine is powered by electricity and is operated by the person using an operations control panel. Only one unit is required for a person's use. The machine does not require attachments and is fully portable. The motion created by the motors allows for the movement of the pivoting foot platform and the longitudinal movement of the flat moving board which create the automatic movement of the lower limbs at adjustable speed within a pre-set parameter.

When operated in the manner prescribed by the method stipulated herein, this invention enables the lower limbs of a person to be adequately and properly moved and exercised to assist and achieve the desired results of improved blood and lymph circulation and the reduction of edema, neuropathy, and other diseases common to the lower limbs caused by lack of movement and circulation.

Accordingly, the present invention allows the heretofore-impracticable exercise and proper movement of the lower limbs in order to assist and promote the movement of blood and lymph for circulation by the body. The transfer of such fluids in the body would entail the use of physical, manual assistance of another individual or the self-propelled and manual movement of a person; this would require a person to be free from any physical impediment or disability that would allow them complete and adequate movement and function of their lower limbs. This technique allows necessary movement and exercise to be achieved without expensive manual assistance or complicated, expensive operating machines currently available through medical prescription.

A clear understanding of the key features of the invention summarized may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

This machine moves all muscles of the lower extremities. This machine is adjustable pivot of 20 to 80 rotations per minute moving one to five inches from the ankle's natural 90 degree angle. The moving board moves from 0 to 80 rotations per minute allowing for maximum extension no greater than one foot from the person's natural knee and joint position while seated. Both motors have adjustable speed. These and other objects of the invention will be apparent to those skilled in the art from the description that follows.

### BRIEF DESCRIPTION OF THE DRAWINGS

FIG. 1 is a perspective view of the basic embodiment of the invention.

FIG. 2 is a top view of the apparatus without the foot platform attachment with a top view of the moving board.

FIG. 3 is a perspective view of the front section of the apparatus showing the foot platform embodiment.

### DETAILED DESCRIPTION Of THE DRAWINGS

The present invention utilizes an apparatus for supporting a person's feet with two adjustable positions one in the height of the foot platform and one in the longitudinal length of the movement of the feet in a direction causing the knees to unbend. The foot platform pivots on an adjustable hinge allowing a person to achieve different range of motion passive movement of the feet and legs. The pivoting foot platform is moved by a motor allowing for low speed movement between 0 and 80 rotations per minute. The moving flat board is adjustable at speeds from 20 to 80 rotations per minute. The person is able to adjust speed and movement of the dual action passive motion using a controller device. The apparatus allows a seated person to achieve range of motion in ankles, knees, and hips through dual action passive movement. The person is not required to actively engage in movement of the lower extremities. The person may engage both movements as dual action passive motion or either one of the motions using either the pivoting motion of the foot platform or the longitudinal movement of the moving board. It is appropriate for the embodiment to consist of material of any constructible matter including, but not limited to, wood, plastic, and metal. The apparatus is powered by an electrical power supply using battery or external power supply. The apparatus may include a top, removable encasement to limit access to the moving parts.

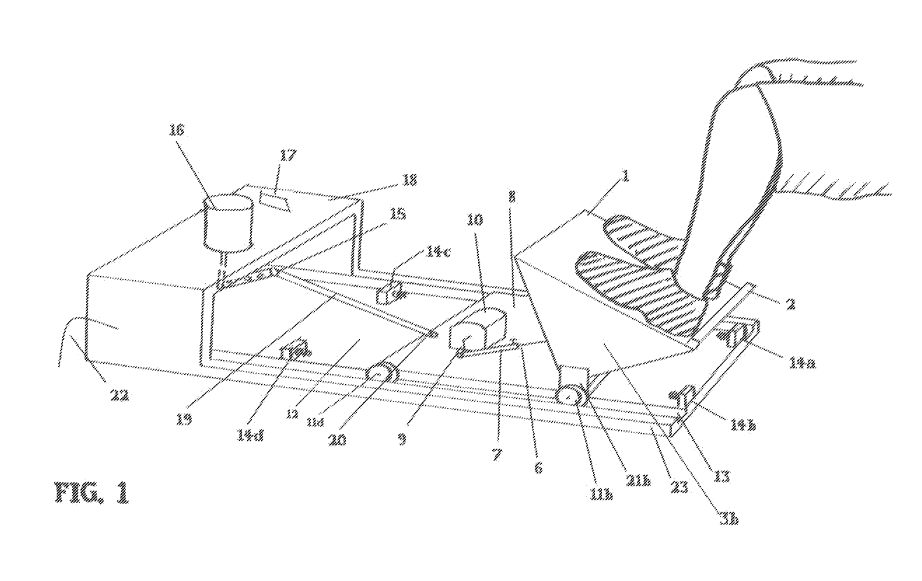

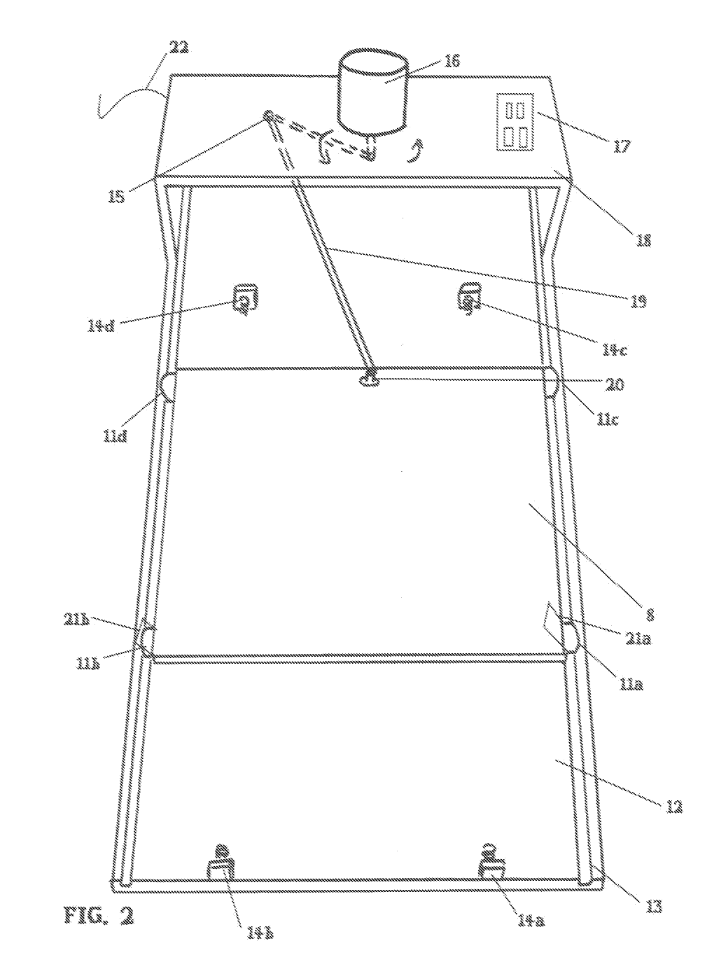

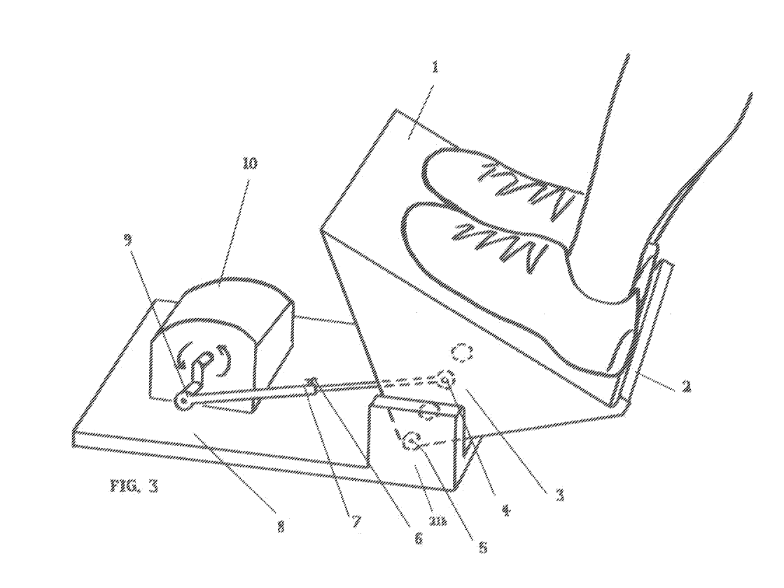

Referring to FIG. 1 the complete embodiment of the dual motion passive action exercise of the lower extremities apparatus is exhibited from a side and top perspective with the placement of a person's feet evident on the pivoting foot platform 1. Detail of the foot platform is evident in FIG. 3 whereas a person's feet are placed flat on the pivoting foot platform 1. A platform lip 2 is attached to the bottom of the pivoting foot platform 1 and the side foot platform support 3 attaches interiorly on one side to the foot platform connection bar 7 which provides an adjustable length connection 6 allowing for the interior connection hinges 4 of the side foot platform support 3 to be adjusted by height. The adjusting of height allows for range of motion to increase or decrease by increasing or decreasing the pivotal action of the entire foot platform 1. Adjustable pivoting movement allows for a comfortable range of motion for persons with different levels of joint flexibility and movement of the ankle, knee, and hip joints. The pivoting foot platform motor 10 is connected to the foot platform connection bar 7 with a motor crank 9 which allows for the pivotal movement of the foot platform 1 by its connection to the side foot platform support 3 which is shown in detail in FIG. 3. The flat moving board 8 is attached to side foot platform support with a wheel attachment 21b. The wheel is shown in FIGS. 1 and 2 as 11b. The remaining wheels are connected to the flat moving board 8 and are noted in FIG. 2 as 11a, 11b, 11c, and 11d and in FIG. 1 as 11b. Wheel attachments 11a and 11b connect to the foot platform 1 while wheels 11c and 11d do not. The wheels 11a, 11b, 11c, 11d are placed on a track 13a and 13b which runs along both sides of the underlying hoard 12.

FIGS. 1 and 2 exhibit four spring stoppers 14a, 14b, 14c, 14d that are connected to the underlying board 12 to control the longitudinal movement of the flat moving board 8. The additional of spring stoppers 14a, 14b, 14c, 14d limit the allowable range of motion for a person's ankle, knee, and hip joints thereby ensuring over extension of the joints will not occur. FIGS. 1 and 2 exhibit how the flat moving board 8 is allowed its longitudinal movement by its connection to the moving board connector bar 19. It is attached to the flat moving board 8 by connector 20. The moving board connection bar 19 includes an adjustable arm 15 to accommodate persons of a variety of height ranges while allowing for the adequate amount of range of motion of the ankle, knee, and hips joints without over or under extension. The moving board connection bar 19 is attached to the moving board motor 16. The motor is controlled by the operations control panel exhibited in FIG. 2 as the operations control panel 17. The moving board motor 16 and the foot platform motor are supplied power by an external power supply 22 or may be battery operated. FIGS. 1 and 2 exhibit the top encasement 18 on which the moving board motor 16 and operations control panel 17 are mounted. The mounted moving board motor 16 could be placed inside the encasement 18. The operations control panel 17 may be hand held by the user of the apparatus.

The present invention has been described in detail with reference to specific embodiments and for allowing various modifications and adjustments in order for a person to achieve dual action passive motion of the ankle, knee, and hip joints and to allow for the full range of motion for which the person is capable of achieving without active resistance. A combination of movement speeds, motor types and speeds, spring types, crank sizes and shapes, wheel types, connection bar sizes, encasement composition, platform composition, moving board composition, underlying board, and other elements of assembly as well as the location of such elements and other motion-imparting elements may be utilized to achieve desired results of the invention without departing from the spirit and scope of the claims as written and constructed herein. The above disclosure is thus intended for the purposes of illustration and not limitation.

What I claim as my invention is:

1. A dual motion passive action exercise and rehabilitation apparatus which creates muscles contractions of the lower extremities.

2. A dual motion passive action exercise and rehabilitation apparatus that allows for the combined or separate movement of a pivoting foot platform and a longitudinal moving flat board.

3. A dual motion passive action exercise and rehabilitation apparatus that utilizes speed, position, and distance within normal ranges of motion of the ankle, knee, and hip joints to allow for the passive exercise of the lower extremities.
